(19) United States
(12) Patent Application Publication
(10) Pub. No.: US 2005/0243794 A1
(43) Pub. Date: Nov. 3, 2005

(54) Method for avoiding and resolving reservation conflict of time slots in wireless network

(75) Inventors: Won-yong Yoon, Yongin-si (KR); Yong-suk Kim, Seo-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/116,384

(22) Filed: Apr. 28, 2005

Related U.S. Application Data
(60) Provisional application No. 60/565,874, filed on Apr. 28, 2004.

(30) Foreign Application Priority Data
Dec. 10, 2004 (KR) 2004-104052

(51) Int. Cl. H04J 3/00

(52) U.S. Cl. 370/347

(57) ABSTRACT

A method for reserving non-colliding time slots by a node in a wireless network and a method for avoiding colliding time slots are provided. A transmitting node or a receiving node broadcasts information relating to its reserved time slot to neighbor nodes. A node in the wireless network recognizes information relating to time slots of neighbor nodes and of neighbor's neighbor nodes. Thus, when reserving a time slot for data transmission, time slot collision can be prevented by selecting the time slot based on the recognized information. If collision occurs in the reserved time slot and the node wants to cancel the reservation, the node informs a correspondent node of the reservation cancellation. Accordingly, the collision can be promptly resolved.

### CROSS-REFERENCE TO RELATED APPLICATIONS

This application claims the benefits from U.S. Provisional Application No. 60/565,874 filed on Apr. 28, 2004 in the United States Patent and Trademark Office, and Korean Patent Application No. 2004-104052 filed on Dec. 10, 2004 in the Korean Intellectual Property Office, the entire disclosures of which are incorporated herein by reference.

### BACKGROUND OF THE INVENTION

1. Field of The Invention

The present invention generally relates to a wireless network including a plurality of nodes. More specifically, the present invention relates to a method for a node in a wireless network to reserve a time slot having no collisions.

2. Description of The Related Art

In general, a wireless network includes a plurality of nodes. The nodes in the wireless network transmit data to and receive data from each other. The nodes conform to a certain rule for the data transmission and reception. If more than two nodes transmit data at the same time, the data collide with each other and erroneous data is received at a receiving node. Thus, the nodes need to transmit data so that the data does not overlap with other data in the wireless network.

A configuration of a wireless network is explained in reference to FIG. 1. FIG. 1 depicts a wireless network including a node A through a node E. The nodes A through E send a beacon in a beacon period to nodes located in a specific range. In FIG. 1, the node A sends a beacon to the nodes B through E, and node B sends a beacon to the nodes A and C. The node C sends a beacon to the nodes A and B, and the node D sends a beacon to the nodes A and E. The node E sends a beacon to the nodes A and D. The node C transfers data to the node B in a reserved time slot, and the node E transfers data to the node D in a reserved time slot.

FIG. 2 depicts a structure of a superframe used by a node in the wireless network. Referring to FIG. 2, the superframe includes a beacon and 256 time slots. The nodes in the wireless network require sync information to synchronize with each other. To this end, the nodes append the sync information to a period of the beacon and send the beacon to their neighbor nodes. The node having data to transmit sends the data using a reserved time slot among the 256 time slots.

For instance, the node C sends data in the time slot 2, and the node B receives data in the time slot 2. The node E sends data in the time slot 3, and the node D receives data in the time slot 3. Referring to FIG. 3 through FIG. 5, the following is an explanation of collision occurrence between time slots that are requested to be reserved.

FIGS. 3A-C illustrate a case when a new node joins a wireless network.

The wireless network includes a node A and a node B. The nodes A and B provide information relating to the reserved time slot to neighbor nodes using a beacon within a beacon period (BP) (S300). The node A sends a request for the time slot reservation to the node B to transmit data (S302). The time slot requested to be reserved by the node A is shown in FIG. 3B. That is, the node A requests to reserve necessary time slots among the existing free time slots. Upon receiving the time slot reservation request from the node A, the node B sends a response to the reservation request (S304). In detail, if the node B determines to accept the time slot requested by the node A, the node B transmits the response (S304). As a result, the nodes A and B can reserve the time slot as shown in FIG. 3B.

It is assumed that the node C reserving the time slot of FIG. 3C joins the wireless network. In this situation, the time slot of the nodes A and B and that of the node C collide as shown in FIG. 3B and FIG. 3C.

FIGS. 4A-C illustrate a case where more than two nodes request to reserve overlapping time slots in a single superframe. Referring to FIG. 4A, the node A sends a request for a time slot reservation to the node B (S402), and the node B responds to the time slot reservation request of the node A (S404). The time slot reserved by the nodes A and B for the data transmission and reception is shown in FIG. 4B. The nodes A and B have received information relating to existing reserved time slots (S400). As the nodes A and B request to reserve a free time slot excluding the existing reserved time slots, the time slot of FIG. 4B is reserved.

The node C sends a request to reserve a time slot to the node D (S406), and the node D responds to the time slot reservation request of the node C (S408). The time slot requested by the nodes C and D for the data transmission and the reception is shown in FIG. 4C. The nodes C and D have obtained information relating to the existing reserved time slots in the beacon period (S400). Accordingly, the nodes C and D request to reserve a free time slot excluding the existing reserved time slots, and thus the time slot of FIG. 4C is reserved. However, the time slot reserved by the nodes A and B (FIG. 4B) collides with the time slot reserved by the nodes C and D (FIG. 4C).

FIG. 5A illustrates a case where a node that intends to reserve a time slot cannot receive a beacon from a node that previously reserved the time slot. The nodes C and D inform neighbor nodes that the time slot of FIG. 5B is reserved using a beacon in a beacon period (S500). Herein, it is assumed that the nodes A and B do not receive the beacon from the nodes C and D due to errors on a radio channel. The node A requests to reserve a time slot for data transmission to the node B (S502). The time slot requested to be reserved by the node A is shown in FIG. 5B. The node B responds to the reservation request of the node A (S504). However, the time slot requested by the nodes A and B (FIG. 5C) collides with the reserved time slot of the nodes C and D (FIG. 5B). Accordingly, solutions are required to reserve a non-colliding time slot and address time slot collisions.

### SUMMARY OF THE INVENTION

The present invention has been provided to address the above-mentioned and other problems and disadvantageous occurring in the conventional arrangement, and an aspect of the present invention provides a method for preventing collisions occurring between reserved bit slots in a wireless network including a plurality of nodes.

Another aspect of the present invention provides a method for addressing collisions occurring between reserved bit slots in a wireless network including a plurality of nodes.

To achieve the above aspects and features of the present invention, a method for a node, which transmits data using a reserved time slot among a plurality of time slots, to reserve the time slot in a wireless network including a plurality of nodes, comprises steps of: receiving information relating to reserved time slots from at least one neighbor node; extracting at least one time slot not colliding with the reserved time slots when data to be transmitted is generated; and transmitting a message requesting the reservation of the extracted time slots to a correspondent node.

Consistent with the above aspects of the present invention, a method for a node, which receives data using a reserved time slot among a plurality of time slots, to reserve the time slot in a wireless network including a plurality of nodes, comprises steps of: receiving information relating to time slots to be reserved from a node which transmits data; determining whether the received time slots collide with stored time slots; and informing the node of the acceptance of the received time slots to reserve when there is no collision.

Consistent with the above aspects of the present invention, a method for avoiding collision in time slots reserved by a node in a wireless network including a plurality of nodes, comprises steps of: comparing at least two reservation times at which the colliding time slots are reserved; and informing a correspondent node of reservation change by a node selected by comparing the reservation times.

### BRIEF DESCRIPTION OF THE DRAWING FIGURES

These other aspects and/or advantages of the invention will become apparent and more readily appreciated from the following description of exemplary embodiments, taken in conjunction with the accompanying drawing figures of which:

FIG. 1 illustrates a wireless network including a plurality of nodes;

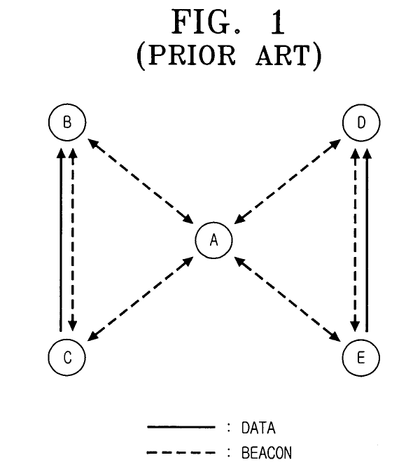

FIG. 2 illustrates a structure of a superframe used by the node in the wireless network;

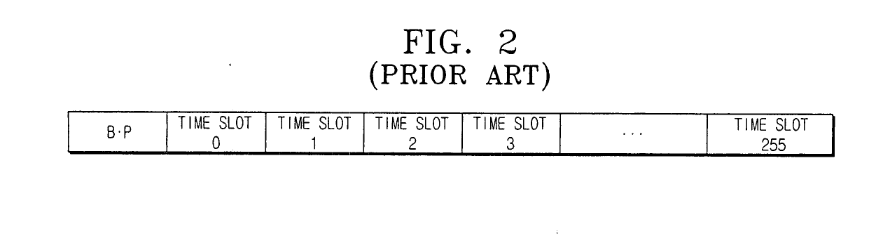

FIGS. 3A-C illustrates a collision of time slots requested to be reserved in a wireless network including a plurality of nodes;

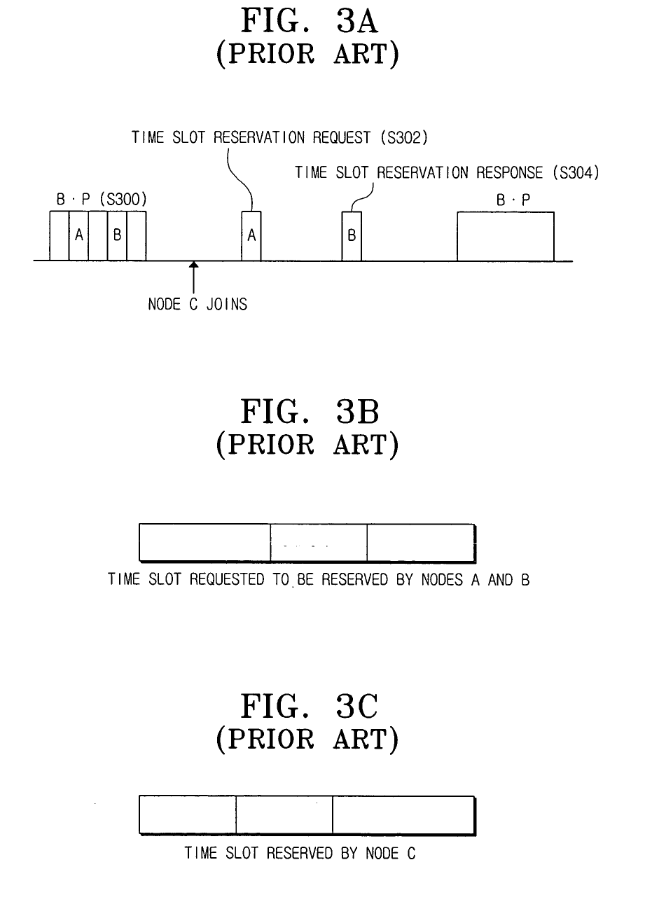

FIGS. 4A-C illustrates a collision of time slots requested to be reserved in a wireless network including a plurality of nodes;

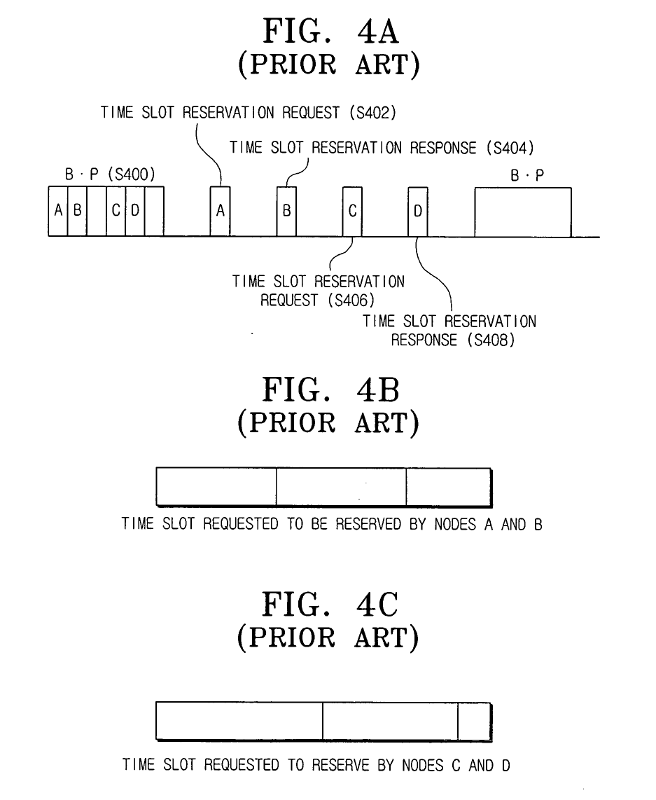

FIGS. 5A-C illustrates a collision of time slots requested to be reserved in a wireless network including a plurality of nodes;

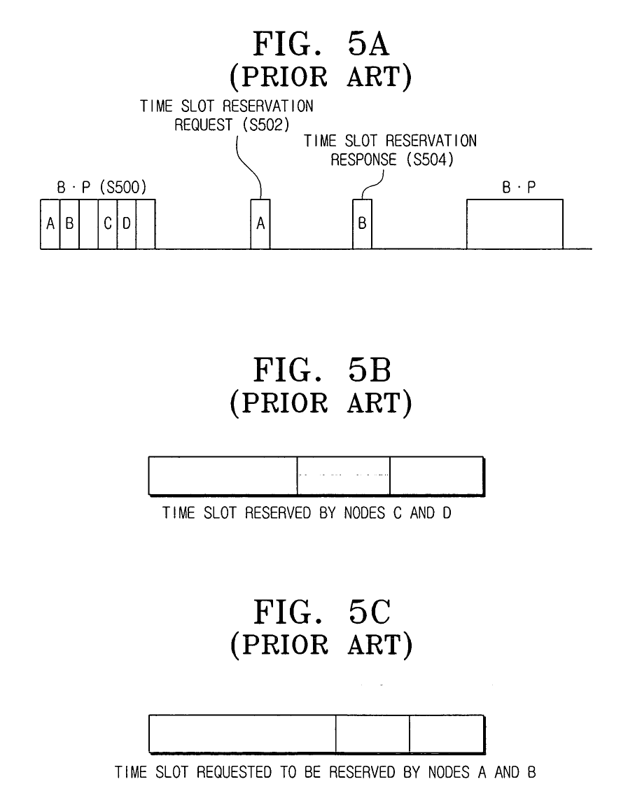

FIG. 6 illustrates collision avoidance of time slots to be reserved in a wireless network including a plurality of nodes according to an embodiment of the present invention; and

FIG. 7 illustrates collision resolution of time slots to be reserved in a wireless network including a plurality of nodes according to an embodiment of the present invention.

### DETAILED DESCRIPTION OF THE EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

A node in a wireless network stores information relating to its reserved time slot and time slots reserved by neighbor nodes. A transmitting node or a receiving node informs neighbor nodes of a reserved time slot using a beacon. The node in the wireless network receives information relating to the reserved time slots from the neighbor nodes, and forwards the received information to other neighbor nodes. The following Table 1 shows information relating to the reserved time slots stored in the node.

TABLE 1

| Node | Location of node | Reserved time slot |
|---|---|---|
| Node 1 | Neighbor node | Time slot 1 |
| Node 2 | Neighbor's neighbor node | Time slot 1 |
| Node 3 | Neighbor's neighbor node | Time slot 3 |
| . | . | . |
| . | . | . |
| . | . | . |
| Node N | Neighbor node | Time slot 6 |

The node recognizes the information relating to the locations and the reserved time slots of the nodes in the wireless network based on Table 1. Although Table 1 shows each node reserves only one time slot, each node can reserve more than one time slot. The node updates the table using information appended to the received beacon. In Table 1, the node 1 and the node 2 transceive data in the reserved time slot 1.

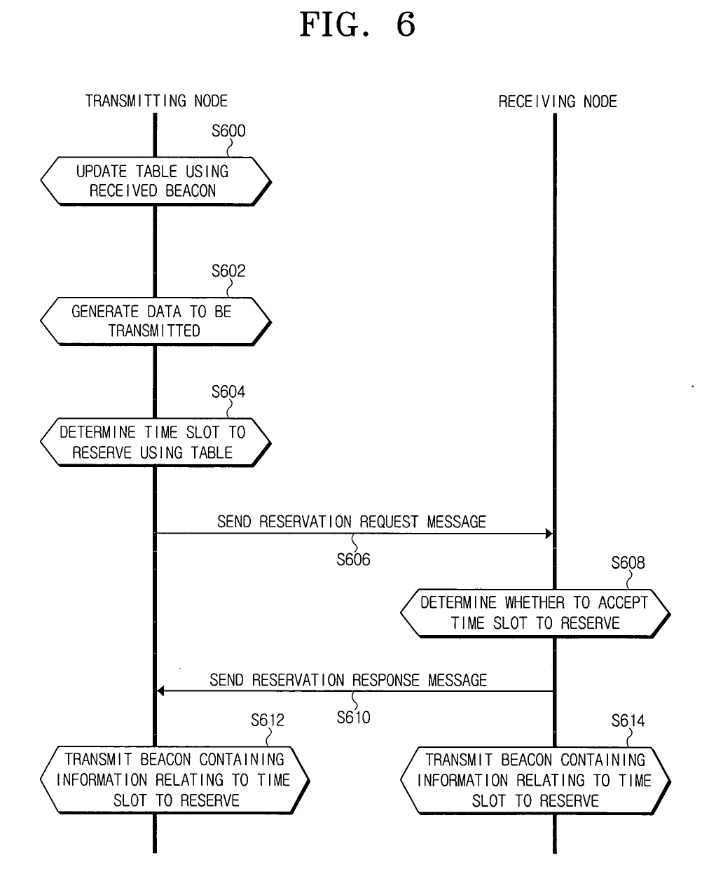

The following is an explanation of a transmitting node reserving a time slot in reference to FIG. 6. The transmitting node updates the table using the received beacon (S600). It should be appreciated that information organized in the table can include other information in addition to the above-mentioned information in Table 1. To facilitate the understanding, Table 1 shows only necessary information.

The transmitting node determines whether data to be transmitted is generated (S602). If so, the transmitting node proceeds to the operation S604, or if not, the transmitting node updates the table using the received beacons (S600).

The transmitting node determines a time slot to reserve based on the table so as to transmit the generated data (S604), which is described in detail.

The transmitting node detects free time slots not reserved by the receiving node or a neighbor node, free time slots not reserved by neighbor nodes of the receiving node, and free time slots not reserved by the neighbor's neighbor nodes. The transmitting node extracts common time slots from the detected time slots. The transmitting node determines the extracted time slots as its time slots to be reserved.

The transmitting node sends a reservation request message to the receiving node (S606). Information relating to the time slots to reserve is appended to the reservation request message.

The receiving node determines whether to accept the requested time slots (S608). To this end, the receiving node extracts free time slots based on the stored table. The receiving node extracts the free time slots in the same manner as the transmitting node extracts the free time slots.

The receiving node determines whether the extracted time slots are identical with the requested time slots from the transmitting node. If so, the receiving node sends a reservation response message (S610). The reservation response message indicates that the requested time slots are accepted. When the extracted time slots are partly identical with the requested time slots, the receiving node sends the reservation response message (S610). The reservation response message contains information relating to the identical time slots.

When the extracted time slots are different from the requested time slots, the receiving node sends a reservation cancel message. The reservation cancel message indicates that the requested time slots for the reservation are not accepted. Upon receiving the reservation cancel message, the transmitting node recognizes that the requested time slots have been already reserved by other nodes. If there are no identical time slots, the receiving node can send to the transmitting node the reservation cancel message containing information related to its extracted time slots. In this situation, the transmitting node carries out the operation S608 using the time slots contained in the reservation cancel message. In other words, if the table is updated based on the received beacon during the operation S602 through the operation S610, the transmitting node can rapidly determine the time slots to reserve based on the time slots contained in the reservation cancel message.

Upon receiving the reservation response message, the transmitting node appends information relating to the time slots to reserve to a beacon and sends the beacon to its neighbor nodes in the beacon period (S612). The receiving node, after transmitting the reservation response message, appends information relating to the time slots to reserve to a beacon and transmits the beacon to neighbor nodes in the beacon period (S614). The information relating to the reserved time slots in the operation S612 is the same as the information in the operation S614. The order of the operation S612 and the operation S614 may change depending on the beacon transmission time of the transmitting node and the receiving node.

The transmitting node determines that the requested time slots are not reserved when the reservation cancel message is received or the beacon from the receiving node does not contain the information relating to the time slots to be reserved. Similarly, the receiving node determines that the requested time slots are not reserved when the reservation cancel message is transmitted or the beacon from the transmitting node does not contain the information relating to the time slots to be reserved.

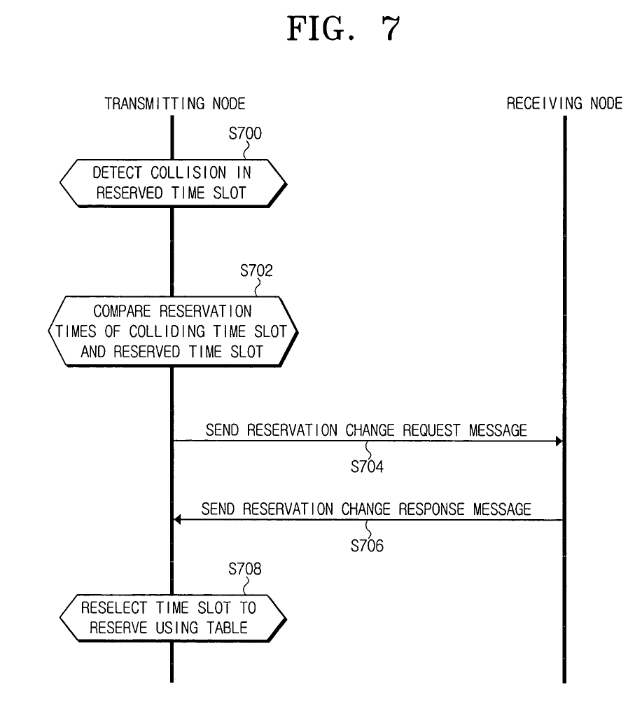

FIG. 7 illustrates the time slot collision resolution according to an embodiment of the present invention, to be explained in detail.

The transmitting node detects collision of its reserved time slots (S700). The collision takes place when another node reserves and uses the time slot of the transmitting node.

The transmitting node compares reservation times with respect to the colliding time slots (S702). That is, the transmitting node compares its reservation time with the reservation time of the other node. According to an embodiment of the present invention, a node having the earlier reservation time occupies the reserved time slot. To this end, each node keeps information relating to its reservation time together with its table when the table is generated or updated, If the reservation time of the transmitting node is later than the other node, the transmitting node sends a reservation change request message to the receiving node (S704). The reservation change request message contains information relating to the colliding time slots. If the transmitting node has the earlier reservation time, the other node gives up the time slots.

Upon receiving the reservation change request message, the receiving node cancels the reservation of the colliding time slot. The receiving node sends a reservation change response message to the transmitting node (S706). The transmitting node reselects a time slot to reserve based on its table (S708). The time slot reselection of the transmitting node is the same as in FIG. 6. If the time slots partly collide, the transmitting node and the receiving node can carry out related operations using an uncolliding time slot, instead of carrying out the operation S708.

The transmitting node can append information of the reservation request message to the reservation change request message (S704). The receiving node can append information of the reservation response message or information of the reservation cancel message to the reservation change response message.

In light of the foregoing as aforementioned, a node, which reserves a time slot, transmits information relating to its reserved time slot to its neighbor nodes so that the neighbor nodes reserve free time slots, to thus avoid time slot collisions. If more than two nodes reserve one time slot and the time slot collision occurs, one node gives up the reserved time slot and provides the other node with information relating to the canceled reservation. As a result, it is possible to promptly resolve the time slot collisions.

While the present invention has been particularly shown and described with reference to exemplary embodiments thereof, it will be understood by those skilled in the art that various changes in form and details may be made therein without departing from the spirit and scope of the invention as defined by the appended claims.

1. A method for a first node, which transmits data using a reserved time slot among a plurality of time slots, to reserve the time slot in a wireless network including a plurality of nodes, comprising:
receiving information relating to reserved time slots from at least one neighbor node;
extracting at least one time slot not colliding with the reserved time slots when data to be transmitted is generated; and
transmitting a message requesting the reservation of the extracted time slots to a correspondent node.

2. The method according to claim 1, wherein information relating to the reserved time slots of the at least one neighbor node and time slots reserved by neighbor nodes of the at least one neighbor node is received from the at least one neighbor node.

3. The method according to claim 2, wherein the first node stores information relating to the reserved time slots and location of the nodes that reserve the time slots.

4. The method according to claim 1, wherein the at least one neighbor node is informed of the reservation of the time slots when the correspondent node informs that the reservation of the time slots is accepted.

5. A method for a first node, which receives data using a reserved time slot among a plurality of time slots, to reserve the time slot in a wireless network including a plurality of nodes, comprising:
receiving information relating to time slots to be reserved from a second node which transmits data;
determining whether the received time slots collide with stored time slots; and
informing the second node of the acceptance of the received time slots to reserve when there is no collision.

6. The method according to claim 5, wherein only information relating to uncolliding time slots is sent to the second node when a part of the received time slots collide with the stored time slots.

7. The method according to claim 5, wherein a correspondent node stores information relating to reserved time slots received from at least one neighbor node.

8. The method according to claim 7, wherein the operation of determining whether the received time slots collide with the stored time slots comprises:
extracting time slots uncolliding with the stored time slots; and
determining non-collision when the extracted time slots are identical with the received time slots.

9. The method according to claim 8, wherein it is informed that the reservation of the received time slots is not accepted when the extracted time slots are not identical with the received time slots.

10. The method according to claim 5, wherein the reservation of the time slots is informed to neighbor nodes after informing that the reservation of the received time slots is accepted.

11. A method for avoiding collision in time slots reserved by a first node in a wireless network including a plurality of nodes, comprising:
comparing at least two reservation times at which colliding time slots are reserved; and
informing a correspondent node of a reservation change by a node selected by comparing the reservation times.

12. The method according to claim 11, wherein a node having a later reservation time is selected.

13. The method according to claim 12, wherein the selected node appends information relating to uncolliding time slots and informs the correspondent node of the information.

14. The method according to claim 13, wherein the correspondent node informs the first node of whether to accept the uncolliding time slots.
